(19) United States
(12) Patent Application Publication
(10) Pub. No.: US 2010/0146416 A1
(43) Pub. Date: Jun. 10, 2010

(54) SYSTEM AND METHOD FOR GENERATING SPECTRUM RIGHTS OFFERINGS

(76) Inventor: Michelle C. Palmer, Altamonte Springs, FL (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/327,912

(22) Filed: Dec. 4, 2008

(51) Int. Cl. G06F 3/00

(52) U.S. Cl. 715/762

(57) ABSTRACT

A system and methods are provided by which a spectrum holder may employ a graphical user interface to generate a spectrum rights offering. A holder may begin by selecting spectrum from which spectrum rights are to be offered. The holder may specify at least one partitioning parameter to partition the selected spectrum by geographic unit, such as county, zip code, etc. The spectrum holder may then identify an offering area by selecting one or more geographic areas corresponding to the geographic unit of the partitioning parameter. The spectrum holder may define various details or parameters for the offering, such as, for example, offering type, applicable dates associated with the offering, and usage restrictions. After the offering details are defined, the holder may price the offering based on a variety of pricing options, such as a set price, price per population, price per area, price per megahertz, and others.

### TECHNICAL FIELD OF THE INVENTION

The technology of the present disclosure relates generally to spectrum management, and, more particularly, to a system and methods for a spectrum holder to generate offerings of spectrum rights.

### BACKGROUND

The telecommunications industry is in the midst of change due to the rapidly improving cost and performance capability of network components. Early telecommunications systems were highly centralized and provided simple services. Today, telecommunications networks (the Internet being an example) are highly distributed, flexible, and provide a variety of services.

Wireless communications continue to gain in popularity, but wireless communications are constrained due to a lack of available, interference free spectrum that may be used for reliable communications within a geographic area. To enhance the availability and reliability of interference free spectrum, systems have been developed regionally for allocating spectrum use.

In the U.S., for example, the Federal Communications Commission (FCC) licenses spectrum in a primary spectrum market to commission licensees. As an example of current spectrum allocation, FIG. 1 shows a portion of the current U.S. frequency allocations at 2.5 GHz. As can be seen in FIG. 1, plural bands of various frequency ranges have been established, and each of these may be allocated to a corresponding commission licensee or reserved for government use. It is noted that regulations specify that stations operating in the 2568-2572 MHz range and the 2614-2618 MHz range are secondary to adjacent channel operations, may not cause interference, and must accept interference from other stations.

A secondary market exists for the commission licensees to sublease spectrum for use by other parties. Conventional secondary market leases involve the wholesaling of a spectrum holder's spectrum to another party. This is a one party to one party transaction in which use rights for an entire monolithic block of spectrum are transferred. In some situations, however, the entirety of the holder's spectrum rights are not being utilized, or may not be desired by a prospective sub-lessor. Under such circumstances, a wholesale transfer of spectrum is not desirable.

### SUMMARY

The present disclosure describes an enhanced system and methods by which holders may generate offerings of apportioned spectrum rights so that the holder may efficiently generate spectrum offerings targeted to a portion of the holder's spectrum rights. The offerings may be disseminated to potential users for the purposes of bidding on or buying spectrum rights.

The system includes a graphical user interface (GUI) that permits a holder to enter license information and generate an offering of spectrum rights therefrom. A spectrum holder may first employ the GUI to select a spectrum license from which spectrum rights may be offered. For example, a spectrum holder may select a license by FCC registration number (FRN) and call sign. A spectrum holder may offer spectrum rights for the entire license, or alternatively may apportion the license into components delineated by geography, frequency block, and/or other parameters.

Once the license has been selected, a spectrum holder may employ the GUI to identify the offering area. For example, a spectrum holder may identify the offering area by selecting one or more partition areas based on the previous apportioning input. The spectrum holder may then define various details or parameters for the offering. As further explained below, for example, such parameters may include an offering type (auction, market, or “select a bid”), whether the offering is a sale or lease, applicable dates, and the like. After the offering details are defined, a spectrum holder may then price the auction based on a variety of pricing options, such as a set price, price per population, price per area, price per megahertz, and the like. Prospective spectrum users may access the offering and provide bids commensurate with the parameters of the offering. In this way, spectrum rights may be efficiently offered and transferred from spectrum holders to spectrum users in the secondary market.

Therefore, an aspect of the invention is a program stored on computer readable medium for generating a spectrum rights offering. The program comprises executable logic to select spectrum from which the offering is to be generated, specify at least one partitioning parameter to partition the selected spectrum, identify an offering area based on the at least one partitioning parameter, price the offering, and generate an offering to which a bid for spectrum rights may be received in response to the offering, the offering being based on the offering area and the price.

According to one embodiment of the program, the selected spectrum comprises spectrum encompassed by an FCC license.

According to one embodiment of the program, the spectrum is selected by receiving an input of an FCC registration number (FRN) and a call sign associated with the FCC license.

According to one embodiment of the program, the at least one partitioning parameter includes a geographic unit for partitioning the selected spectrum.

According to one embodiment of the program, the geographic unit comprises one of county, 5-digit zip code, three digit zip code, state, census block, or an FCC-defined area.

According to one embodiment of the program, the FCC-defined area comprises one of a Major Trading Area (MTA), Basic Trading Area (BTA), Cellular Market Area, or Economic Area Grouping.

According to one embodiment of the program, the program further comprises executable logic to disaggregate the spectrum by specifying at least one frequency block.

According to one embodiment of the program, the offering area is identified by selecting at least one geographic area corresponding to a geographic unit of the partitioning parameter.

According to one embodiment of the program, the offering price is distributed such that each selected geographic area contributes to an overall offering price in a proportion weighted based on population within the corresponding geographic area.

According to one embodiment of the program, the offering price is distributed such that each selected geographic area contributes to an overall offering price in a proportion further weighted based on physical area within the corresponding geographic area.

According to one embodiment of the program, the offering price is a geographic unit based price such that each selected geographic area contributes an equal amount to an overall offering price.

According to one embodiment of the program, the offering area is identified by receiving a map-based input by which a user inputs the offering area directly onto a map display.

According to one embodiment of the program, the program further comprises executable logic to identify an offering type.

According to one embodiment of the program, the offering type is one of an auction offering, a market offering, or a select a bid offering that allows a holder of the selected spectrum to accept one of plural bids.

According to one embodiment of the program, the offering type is an auction, and the program further comprises executable logic to specify an auction start date and an auction length.

According to one embodiment of the program, the offering type is one of a market or select a bid offering, and the program further comprises executable logic to specify a start date and a bid period.

According to one embodiment of the program, the offering type comprises one of a sell offering or a lease offering.

According to one embodiment of the program, the offering type is a lease offering, and the program further comprises executable logic to specify a lease period.

According to one embodiment of the program, the program further comprises executable logic to identify at least one restriction on the usage of the offered spectrum.

According to one embodiment of the program, the offering type is one of an auction or a select a bid offering, and the offering is priced by receiving an input of a reserve price for the offering.

According to one embodiment of the program, the offering type is a market offering, and the offering is priced by receiving an input of an asking price for the offering.

According to one embodiment of the program, the offering is priced for the offering area by receiving an input of at least one of price per population, price per square mile, price per megahertz, or price per geographic unit that is smaller than the partitioning parameter.

According to one embodiment of the program, the offering is priced by receiving an input for each geographic area within the offering area of at least one of price per population, price per square mile, price per megahertz, or price per geographic unit that is smaller than the partitioning parameter.

According to one embodiment of the program, the program, when executed, comprises a graphical user interface for generating the spectrum rights offering.

According to another aspect of the invention, a method for generating a spectrum rights offering comprises the steps of selecting spectrum from which the offering is to be generated, specifying at least one partitioning parameter to partition the selected spectrum, identifying an offering area based on the at least one partitioning parameter, pricing the offering, and generating an offering to which a bid for spectrum rights may be received in response to the offering, the offering being based on the offering area and the price.

According to one embodiment of the method, the selected spectrum comprises spectrum encompassed by an FCC license.

According to one embodiment of the method, the spectrum is selected by receiving an input of an FCC registration number (FRN) and a call sign associated with the FCC license.

According to one embodiment of the method, the at least one partitioning parameter includes a geographic unit for partitioning the selected spectrum.

According to one embodiment of the method, the geographic unit comprises one of county, 5-digit zip code, three digit zip code, state, census block, or an FCC-defined area.

According to one embodiment of the method, the FCC-defined area comprises one of a Major Trading Area (MTA), Basic Trading Area (BTA), Cellular Market Area, or Economic Area Grouping.

According to one embodiment of the method, the method further comprises disaggregating the spectrum by specifying at least one frequency block.

According to one embodiment of the method, the offering area is identified by selecting at least one geographic area corresponding to a geographic unit of the partitioning parameter.

According to one embodiment of the method, the offering price is distributed such that each selected geographic area contributes to an overall offering price in a proportion weighted based on population within the corresponding geographic area.

According to one embodiment of the method, the offering price is distributed such that each selected geographic area contributes to an overall offering price in a proportion further weighted based on physical area within the corresponding geographic area.

According to one embodiment of the method, the offering price is a geographic unit based price such that each selected geographic area contributes an equal amount to an overall offering price.

According to one embodiment of the method, the offering area is identified by receiving a map-based input by which a user inputs the offering area directly onto a map display.

According to one embodiment of the method, the method further comprises identifying an offering type.

According to one embodiment of the method, the offering type is one of an auction offering, a market offering, or a select a bid offering that allows a holder of the selected spectrum to accept one of plural bids.

According to one embodiment of the method, the offering type is an auction, and the method further comprises specifying an auction start date and an auction length.

According to one embodiment of the method, the offering type is one of a market or select a bid offering, and the method further comprises specifying a start date and a bid period.

According to one embodiment of the method, the offering type comprises one of a sell offering or a lease offering.

According to one embodiment of the method, the offering type is a lease offering, and the method further comprises specifying a lease period.

According to one embodiment of the method, the method further comprises identifying at least one restriction on the usage of the offered spectrum.

According to one embodiment of the method, the offering type is one of an auction or a select a bid offering, and the offering is priced by receiving an input of a reserve price for the offering.

According to one embodiment of the method, the offering type is a market offering, and the offering is priced by receiving an input of an asking price for the offering.

According to one embodiment of the method, the offering is priced for the offering area by receiving an input of at least one of price per population, price per square mile, price per megahertz, or price per geographic unit that is smaller than the partitioning parameter.

According to one embodiment of the method, the offering is priced by receiving an input for each geographic area within the offering area of at least one of price per population, price per square mile, price per megahertz, or price per geographic unit that is smaller than the partitioning parameter.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a schematic representation of U.S. spectrum allocations at around 2.5 GHz.

FIG. 2 is a schematic graph of disaggregated blocks of spectrum use rights that may be transferred from a corresponding spectrum holder to a spectrum user.

FIG. 3 is a schematic diagram depicting operative portions of an exemplary electronic device for use with the disclosed system.

FIG. 4 is a schematic diagram depicting an exemplary communications system for providing the disclosed system.

FIG. 5 depicts an overview of an exemplary method by which a spectrum holder may generate a spectrum rights offering.

FIGS. 6A-6C depict screenshots of a portion of an exemplary GUI from which a spectrum holder may select an FCC license for offering spectrum rights.

FIG. 7 depicts a screenshot of a portion of an exemplary GUI from which a spectrum holder may identify an offering area for offering spectrum rights.

FIGS. 8A-8D depict screenshots of a portion of an exemplary GUI from which a spectrum holder may define offering details for an offering of spectrum rights.

FIGS. 9A-9B depict screenshots of a portion of an exemplary GUI from which a spectrum holder may specify the price parameters for an offering of spectrum rights.

FIG. 10 depicts a screenshot of a portion of an exemplary GUI that provides a spectrum holder with a summary and submission option for an offering of spectrum rights.

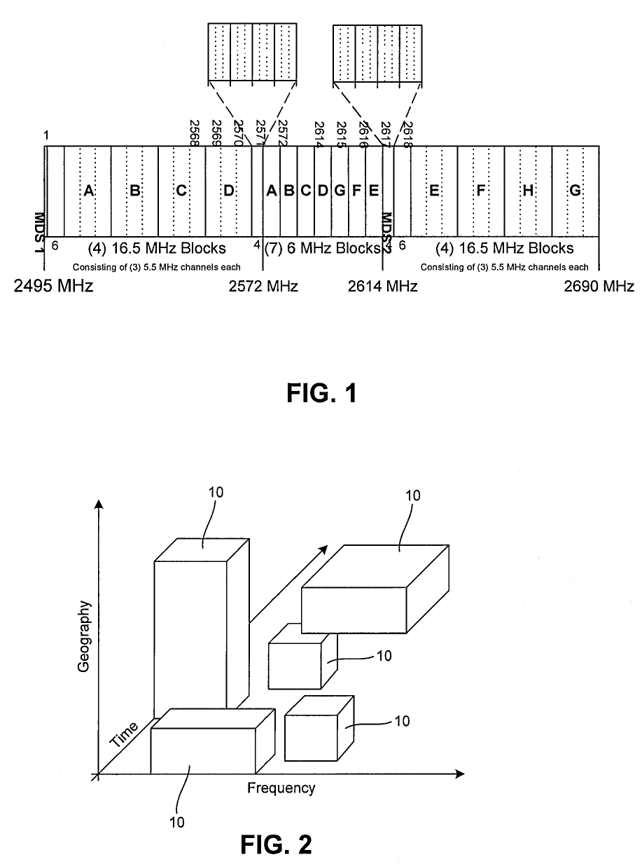

### DETAILED DESCRIPTION OF EMBODIMENTS

Embodiments will now be described with reference to the drawings, wherein like reference numerals are used to refer to like elements throughout. It will be understood that the figures are not necessarily to scale. Before describing the details of exemplary systems and methods for generating offerings of spectrum rights, common terms are explained.

### Explanation of Common Terms

In this document, described are various entities that have a relationship to electromagnetic spectrum for use in wireless communications. One entity is a spectrum holder, or simply a holder. A holder is any entity having the authority to release spectrum use to another entity by granting the other entity access to the spectrum. The granting of access may be a temporary permission to use spectrum that is associated with the holder. Therefore, the access grant need not be a lease or a sub-lease, as defined by the FCC. The holder may be, but is not limited to, a government or regulatory agency (e.g., in the United States, the FCC), a Commission licensee (e.g., in the United States, an entity that has licensed spectrum directly from the FCC in the primary spectrum market), or a secondary market licensee.

Another entity is a spectrum user, or simply a user. A user is any entity or wireless communications system that has a need for spectrum in order to carry out wireless communications. A user also may be a holder.

Each segment of spectrum for which access permission may be transferred may be identified by several components, and each component is defined by one or more variables. Exemplary components include a time window, a frequency-based spectral mask, a geographic area, and a transmitted power limit. The time window may be a period of time that has a starting point given by a day and time and an ending point given by a day and time. Alternatively, the time window may be a period of time specified by a starting time and duration. The time window may be as short as seconds and as long as years.

The frequency-based spectral mask, as is known in the art, may be a mathematically defined set of lines applied to levels of radio transmission. The frequency-based spectral mask is generally intended to reduce interference by limiting excessive radiation at frequencies beyond a certain bandwidth. Spectral masks often include a center frequency and/or a frequency range. Also, spectral masks often include an absolute power component or a relative power component. For an absolute power component, the frequency-based spectral mask may specify that transmission beyond a specified frequency range must be below a specified power value. For a relative power component, the frequency-based spectral mask may specify that transmission beyond a specified frequency range must be below a relative power value as determined by a function, such as a specified power value below the total amount of power being transmitted.

The geographic area may include a defined geographical boundary beyond which operating radios may not appreciably transmit. The geographical boundary may be a complex construct that relates to a contiguous or non-contiguous area. The amount of permissible transmission beyond the geographical boundary may be determined in an absolute manner or a relative manner. For an absolute manner, the geographic boundary may provide that transmissions beyond the boundary must be below a specified power value. For a relative manner, the geographic boundary may provide that transmission beyond the boundary must be below a relative power value as determined by a function, such as a specified power value below the total amount of power being transmitted. In one embodiment, the function used for calculating the relative power value may include a distance parameter so that the relative power value may be calculated as a function of distance away from the boundary or other geographical reference.

The geographic area, alone or in combination with the time window, the frequency-based spectral mask and the transmitted power limit, may be established to control an amount of interference that a user system generates with respect to continued operations of the spectrum holder and/or other users.

The transmitted power limit may be a power value that radios operating in accordance with the transmitted power limit may not exceed. The transmitted power limit may be absolute or relative. The transmitted power limit may be independent of the frequency-based spectral mask and/or the geographic area. The transmitted power limit may be expressed as an average power value (e.g., average total power), a peak power value, or similar value. Exemplary transmitted power limits are 500 milliwatts (mW), one watt (W), 1,000 watts, etc.

With additional reference to FIG. 2, the components that identify a block of spectrum (e.g., the time window, the frequency-based spectral mask, the geographic area, and/or the transmitted power limit) may combine to form a spectrum commodity item 10. The graph of FIG. 2 schematically illustrates apportioned blocks of spectrum in three dimensions, including time, space (or geography) and frequency which may be respectively specified with more particularity by the time window, the geographic area and the frequency-based spectral mask. Each spectrum commodity item 10 may be associated with use rights that may be transferred from a corresponding spectrum holder to a spectrum user. The spectrum commodity item may have an associated monetary or non-monetary value, or may not be associated with a value.

When a spectrum holder's rights are subdivided into smaller commodity items, the holder's spectrum is referred to as “apportioned”. A holder may apportion its spectrum according to any combination of geography (referred to as “partitioning” the holder's spectrum), frequency or channel plan (referred to as “disaggregating” the holder's spectrum), and time (referred to as “time-slicing” the holder's spectrum). For example, a license may be partitioned into one or more parts along any geographic boundary that is inside the original license area. Identifiable partition areas may be as small as a single city block (or smaller) or as large as a state or entire national region, as long as each partition fits inside the original license boundary. Disaggregation of licensed spectrum refers to the situation where a spectrum holder divides up a spectrum license by frequency or channels. For example, a 10 MHz license could be disaggregated into two 5 MHz parts, or ten 1 MHz parts, or any other combination totaling up to, but not exceeding the entire licensed amount. Each apportioned spectrum commodity item may relate to a definable amount of spectrum from spectrum that is allocated to a holder so as to identify unused or underutilized spectrum that may be made available for use by another entity or by the holder in a more productive manner.

Spectrum users are often interested in obtaining access to spectrum for a particular application, such as enterprise applications, two-way communications, point-to-point microwave transmissions, point-to-multipoint communications, cellular communications, mobile broadband communications, and so forth. It will be appreciated that this list is in no way exhaustive of the possible communication applications of potential users. Historically, spectrum users have gained spectrum access for their application(s) by obtaining a license or a secondary market license for spectrum that supports the desired application. In this historical sense, the spectrum associated with the license is defined by a geographical area, a spectral mask, a frequency (or set of frequencies) and one or more service rules. In the U.S., service rules are typically specified under an FCC “Part” number. The service rules under each license refer to an application and/or the type of radio technology that may use the licensed spectrum. While the service rules are typically commensurate with the user's desired application, the licensed spectrum effectively is limited for a stated purpose, although several types of uses may fall within the purpose as governed by the service rules associated with the license.

In some situations, a prospective spectrum user may be interested in a targeted transfer of spectrum use rights, rather than a wholesale transfer of a spectrum holder's spectrum as found in conventional secondary market leases in which an entire monolithic block of spectrum is transferred. In these situations, the user may seek access to one or more portions of a holder's rights. For example, a user may desire access to spectrum limited by a variety of criteria, such as frequency band, geographic area, and time. For example, a user that seeks to provide broadband services to a specific location may desire 2.5 MHz of bandwidth in two adjacent zip codes, beginning on a predetermined date. It will be appreciated that other users may desire spectrum rights in accordance with different criteria.

In addition, spectrum holders that have use rights to spectrum may seek to allow others to use spectrum that is otherwise unused or underutilized, or will become unused or underutilized in the future. For example, within a given geographic area and for a given frequency range and time, a holder may use the spectrum in only a portion of the geographic area. A holder also may have transferred use rights in the spectrum that span other portions of the geographic area. Still, there may be geographic gaps in the usage of the spectrum for the geographic area, or, in other words, there may be portions of the geographic area in which a holder has rights, but the spectrum is not being used to its fullest extent. These portions of spectrum may provide a holder additional opportunities to transfer portions of spectrum, thereby increasing the potential value of the spectrum as a whole to the holder. From the perspective of a prospective user, spectrum that may be apportioned from the balance of a holder's spectrum may provide opportunities to acquire spectrum use rights in a more targeted manner suitable to the prospective user's needs. Therefore, there is a need to facilitate matching of a holder's available spectrum with a user's spectrum needs.

The type or types of radio devices that use the spectrum are not germane to the underlying systems and methods described herein. As such, the systems and methods may be applied in any operational context for wireless communications, and wireless communications are expressly intended to encompass unidirectional signal transmissions (e.g., broadcasting of a signal for receipt by a device without response) and to encompass bidirectional communications where devices engage in the exchange of signals. The methods and systems may be applied to dumb and/or cognitive radio devices. The methods and systems may be applied to licensed or unlicensed spectrum. Furthermore, the methods and systems are generic to modulation schemes, harmonic considerations, frequency bands or channels used by the radio devices, the type of data or information that is transmitted, how the radio devices use received information, and other similar communications considerations. Thus, the systems and methods have application in any suitable environment.

### Exemplary System Components for Generating Spectrum Offerings

The following describes a system and methods for a spectrum holder to generate offerings of spectrum rights, and an associated graphical user interface (GUI). The system is described primarily with respect to spectrum offerings based on spectrum allocated in the United States (U.S.) by the FCC. It will be appreciated, however, that the system may be used in connection with spectrum allocated by regulatory agencies other than the FCC, including non-U.S. national or regional regulatory agencies. The system may be employed by spectrum holders with any suitable electronic device having a display and an input interface. Examples of suitable electronic devices may include a desktop or laptop computer, a personal digital assistant (PDA), and comparable communications equipment.

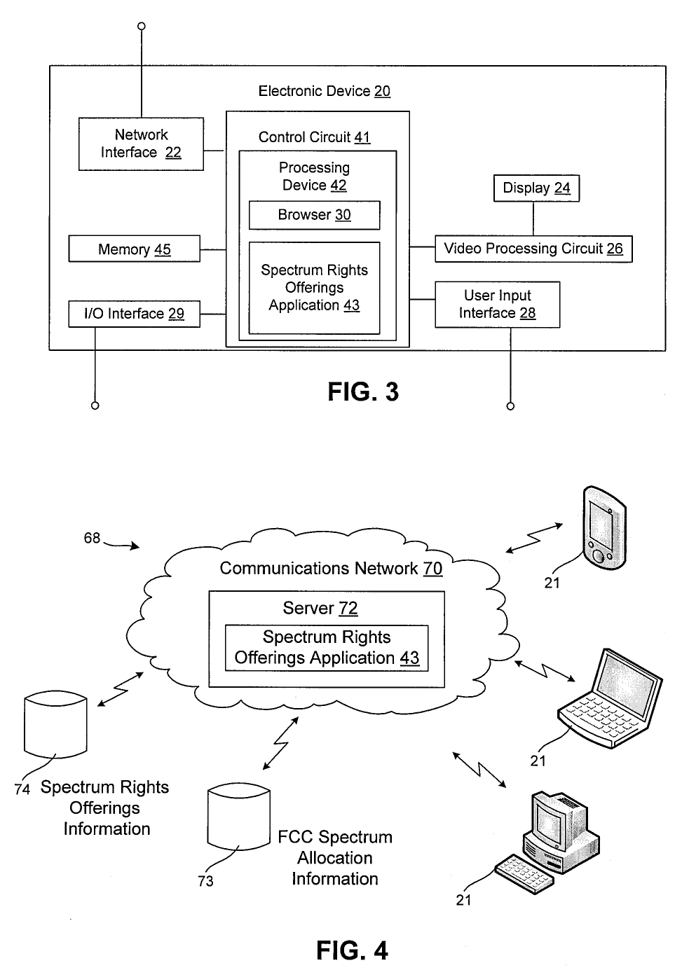

FIG. 3 represents a functional block diagram of operative portions of an electronic device 20 that may execute a spectrum rights offerings application 43. The application 43 may be embodied as executable program code that is resident in and executed by the electronic device 20. The electronic device 20 may include a controller that executes the program code stored on a computer or machine-readable medium. The controller may include a control circuit 41 and/or a processing device 42. Application 43 may be a stand-alone software application or form a part of a software application that carries out additional tasks related to the electronic device 20. It will be apparent to a person having ordinary skill in the art of computer programming how to program an electronic device to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention. Also, through the following description, exemplary techniques for implementing a spectrum rights offering and method are described. It will be appreciated that through the description of the exemplary techniques, a description of steps that may be carried out in part by executing software is described. The described steps are the foundation from which a programmer of ordinary skill in the art may write code to implement the described functionality. As such, a computer program listing is omitted for the sake of brevity. However, the described steps, when implemented in software and executed by a processor or control assembly, describe the structure of an apparatus.

The electronic device 20 may include a browser 30, such as a web browser for accessing content over the Internet or comparable external network. The browser may be a stand-alone function, or may be executed by the control circuit 41. A network interface 22 may be present for establishing a wired or wireless interface with an external network.

The electronic device 20 may include a display 24 for displaying information to a user. The display 24 may be coupled to the control circuit 41 by a video processing circuit 26 that converts video data to a video signal used to drive the display. The video processing circuit 26 may include any appropriate buffers, decoders, video data processors and so forth.

The electronic device 20 may include a user input interface 28 that permits a user to enter a variety of text, data, control, and other inputs. The user input interface may include one or more input devices, examples of which may include a keyboard, keypad, soft keys, mouse, pointer, stylus, and similar input instruments, and combinations thereof. In conjunction with one or more of these user input devices, the display 24 may include a touch screen surface for receiving inputs from a user directly onto the display.

The electronic device 20 may include an I/O interface 29 that permits connection to a variety of conventional I/O devices. Such devices may include equipment for transmitting or manipulating content obtained by electronic device 20, such as printers, faxes, scanners, and the like.

Although the various components of the electronic device 20 are depicted in FIG. 3 as being integrated into a single device, other component configurations may be employed. For example, in a laptop computer, the various components may be integrated into a single physical device, as depicted in FIG. 3. Alternatively, the various components may be segregated into separate physical devices. For example, electronic device 20 may be a desktop computer in which the display and one or more user input interfaces are physically separate from the other components. As further described below, the spectrum rights offering features of the application 43 may be hosted by a network server that is accessible by one or more client devices over the network. In this embodiment, the browser 30, user input interface, and the display would be components of the client devices, with program application 43 being accessed from and executed by the network server. Other component configurations may be employed as well.

FIG. 4 is a schematic diagram depicting an exemplary communications system 68 for providing the disclosed system. FIG. 4 depicts several electronic devices that comprise client devices 21 operating as part of a communications system 68, such as the Internet. The system 68 may include a communications network 70 having a server 72 (or servers) that communicate with participating electronic devices (e.g., the client devices 21). As will be appreciated, the server 72 may be configured as a typical computer system used to carry out server functions and may include a processor configured to execute software containing logical instructions that embody the functions of the server 72 and a memory to store such software.

In one embodiment, the server 72 may host the application 43 for access by the client devices 21. For instance, the application 43 may have a front-end interface that may be accessed by client devices 21 using conventional Internet browsing functionality.

The application 43, when executed by a user device or hosted remotely, may access a database 73 containing FCC spectrum allocation and license information. As stated above, the database 73 may be maintained by the FCC or some other third party. In addition, the communications system may include a second database 74 containing information regarding spectrum rights offerings. Although shown as a single database, it will be appreciated that spectrum rights offerings information may be spread over a plurality of databases. In addition, the FCC spectrum allocation information and the spectrum rights offerings information may be wholly or partly combined into one or more databases.

Conventionally, spectrum allocation and license information are contained in one or more databases that are accessible over the Internet or a comparable network. For example, the FCC maintains a network of text-based databases regarding spectrum that has been allocated to primary market licensees, although other private or government organizations may compile comparable information into a database. In addition, spectrum holders or other interested entities (e.g., sublicensees) may compile information regarding spectrum usage and available spectrum rights. For instance, deployed radius and/or spectrum sniffers may generate data from which current spectrum usage may be determined. Also, historical spectrum usage and/or other knowledge sources may be used to predict future spectrum usage. Such spectrum usage information similarly may be contained in one or more network databases, such as the databases 73 and/or 74 in FIG. 4.

Spectrum allocation and usage information may be employed to identify opportunities for the transfer of rights to unused or underutilized spectrum in the secondary market. In particular, spectrum holders may generate spectrum rights offerings, which may then be bid upon by prospective spectrum users. Rights to apportioned spectrum may then be awarded to users who have submitted favorable bids. The transfer of spectrum rights may be incorporated into a membership-based system, in which spectrum holder members provide offerings, to which member users respond with appropriate bids. For holders, the incentive for joining such a membership-based system is the improved capability for holders to widely publicize the existence of available spectrum and associated offerings. For users and prospective users, the incentive is a convenient and efficient manner to identify desired and available spectrum, for which use rights may then be bid upon from holders. The result is the enhanced ability to transfer spectrum use rights from holders to users.

### Exemplary GUI for Generating Spectrum Rights Offerings

The current disclosure describes an aspect of a system for transferring spectrum rights from holders to users. Specifically, the current disclosure pertains to an aspect of such a system that permits spectrum holders to generate offerings of available spectrum rights. The offerings may be accessed and viewed by prospective spectrum users, who may then place bids for the spectrum rights if a user deems such rights as suitable for an intended use.

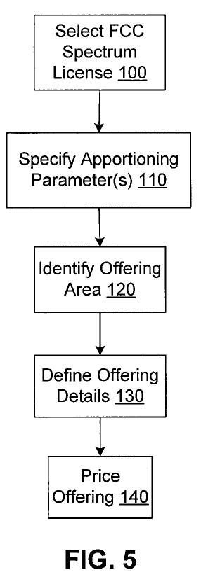

FIG. 5 depicts an overview of an exemplary method by which a holder may generate a spectrum rights offering. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. It will be appreciated that FIG. 5 represents an overview, and more specific details regarding each aspect of the system are provided below.

The method may begin at step 100, at which a spectrum holder may select spectrum from which spectrum rights may be offered. For example, a spectrum holder may specify an FCC license by registration number (FRN) and license call sign. A spectrum holder may offer spectrum rights for the entire license. Commonly, however, a spectrum holder may desire to apportion spectrum associated with a license and offer only a portion of the licensed spectrum, such as if other portions are being used by other spectrum users or the spectrum holder itself. At step 110, therefore, a spectrum holder may specify at least one apportioning parameter to apportion the selected spectrum. The apportioning parameter may partition the selected license into geographic components by county, zip code, FCC-defined region, or other geographic areas encompassed by the license. The spectrum holder may also disaggregate the spectrum by frequency block within the spectral mask of the license. Common FCC-defined regions are described below.

At step 120, the spectrum holder may identify an offering area by selecting one or more of the partition areas based on the specified geographic partitioning parameter. For example, if a holder desires to partition the spectrum by county, the holder may specify one or more counties within the licensed area to be included in the offering. At step 130, the spectrum holder may define various details or parameters for an offering. As further explained below, for example, such parameters may include an offering type (auction, market, or “select a bid”), whether the offering is a sale or lease, applicable dates, and others. After the offering details are defined, at step 140 the spectrum holder may price the auction based on a variety of pricing options, such as a set price, price per population, price per area, price per megahertz, and others.

Additional details of the above method will now be described with reference to an exemplary GUI that a holder may employ to generate a spectrum rights offering. It will be appreciated that the specific GUI described herein is for explanatory purposes and is not intended to limit the scope of the invention. The GUI's configuration, content, and format, therefore, may be varied.

As stated above with reference to FIGS. 3 and 4, a spectrum holder may generate a spectrum rights offering by executing a spectrum rights offerings application 43. If application 43 is internal to the holder's electronic device, the holder may execute application 43 by selection from a menu, applying a dedicated key input, or by any conventional means. If application 43 is hosted in whole or in part on a network server, the spectrum holder may access and execute the application 43 with a browser as is also conventional. If the system is membership-based, the spectrum holder may have an account which may be accessed over the network. The account may include information about the spectrum holder's various holdings, and any outstanding offerings that have previously been generated. The account also may include bid information from users who have bid upon any such offerings. The account may be secured using login, password, and/or similar security devices as are known in the art. Application 43, therefore, may be accessed and executed in a variety of ways.

As stated above, a user may begin generating an offering by selecting spectrum from which an offering is to be made. In one embodiment, the selected spectrum is spectrum that corresponds to an FCC license. FCC license information may be obtained by linking to a database of FCC spectrum allocation information 73, as seen for example in FIG. 4.

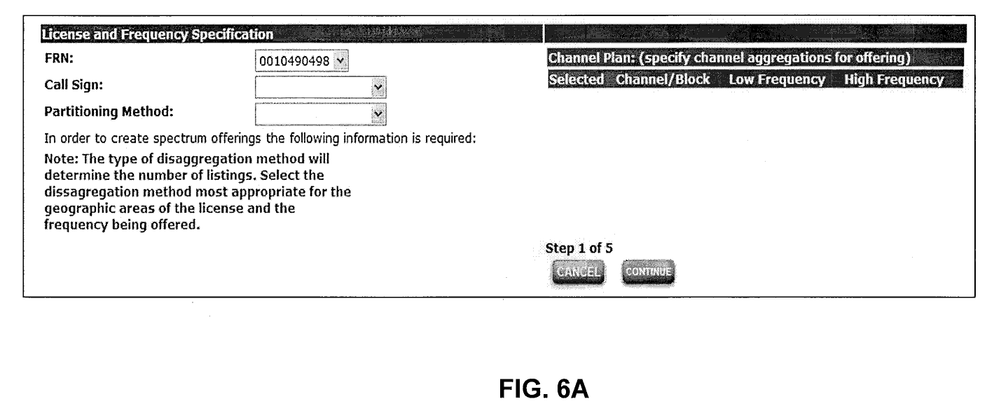

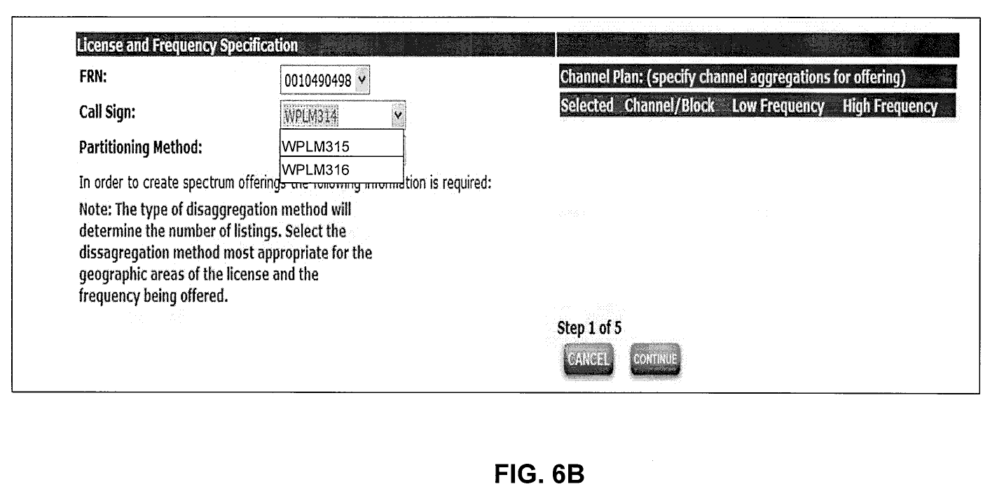

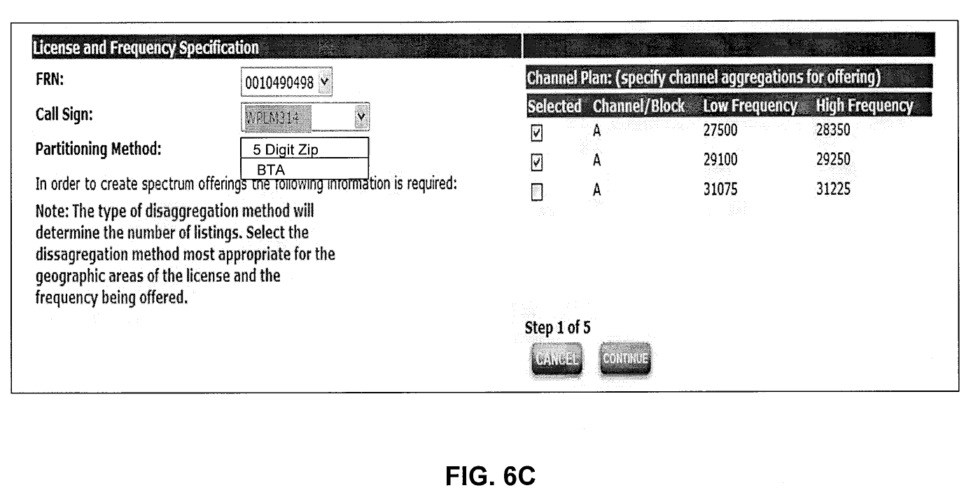

FIGS. 6A-6C depict screenshots of a portion of an exemplary GUI from which a spectrum holder may select an FCC license for offering spectrum rights. As seen in FIG. 6A, a spectrum holder may first specify an FCC registration number (FRN) associated with the holder. As is known in the art, an FRN is an identification number obtained from the FCC by any entity wishing to do business with the FCC. Note that for organizational or other business purposes, a single entity may obtain more than one FRN. For example, an entity may desire an FRN for each division or subsidiary, or may desire an FRN for each category of business (e.g., Internet service, cellular telephone service etc.). Because a spectrum holder may obtain more than one FRN, FIG. 6A depicts the FRN input as a conventional dropdown menu from which one FRN may be selected.

As depicted in FIG. 6B, once a spectrum holder selects an FRN, the spectrum holder may select a “call sign” corresponding to a particular FCC spectrum license. As is known in the art, a call sign is a character set generated by the FCC that identifies a particular license. As seen in the example of FIG. 6B, three call signs are associated with the selected FRN. This means that the spectrum holder has three FCC spectrum licenses associated with the particular FRN selected. Similar to the FRN, FIG. 6B depicts the call sign input as a conventional dropdown menu from which a call sign (FCC license) may be selected from the list. The first call sign (WPLM314) has been selected in this example, as indicated by the shading.

Referring to the example of FIG. 6C, having selected call sign WPLM314, the GUI causes the display of the “channel plan” associated with the selected call sign. As is known in the art, the channel plan includes the spectrum frequency bands or blocks that form the spectral mask of the license. In the example of FIG. 6C, the call sign (license) WPLM314 includes three licensed channels or frequency blocks. At this stage, a spectrum holder may choose to apportion the licensed spectrum to generate an offering of apportioned spectrum rights. For example, a spectrum holder may disaggregate the spectrum by specifying a subset of the licensed frequencies to include in the offering. This is depicted in FIG. 6C by the inclusion of check marks in the first two blocks, indicating that these blocks are to be included in the offering.

A spectrum holder may also partition the licensed spectrum geographically. For example, conventional geographic definitions may be used to partition the licensed spectrum by geographic boundaries such as postal zip code, county, city, census block, state (or portions of any thereof), latitude/longitude coordinates, world geodetic system (WGS) coordinates, or any others as may be convenient for a user. In addition, the FCC has established multiple, and sometimes overlapping, categories for dividing the United States into areas or regions for the purpose of assigning area-based spectrum licenses, referred to herein as “FCC defined areas”. For example, the FCC has divided the United States into 51 Major Trading Areas (MTAs), which are further subdivided into approximately 500 basic trading areas (BTAs). Other FCC defined areas include Cellular Market Areas, Economic Area Groupings, and others. FIG. 6C depicts an exemplary dropdown menu that includes three potential selections for geographic partitioning, including partitioning by county, postal code and BTA. It will be appreciated that the geographic partitioning options may include numerous additional or alternative options based on a variety of conventional or FCC defined geographic areas. In the example of FIG. 6C, partitioning by county has been selected, as indicated by the shading.

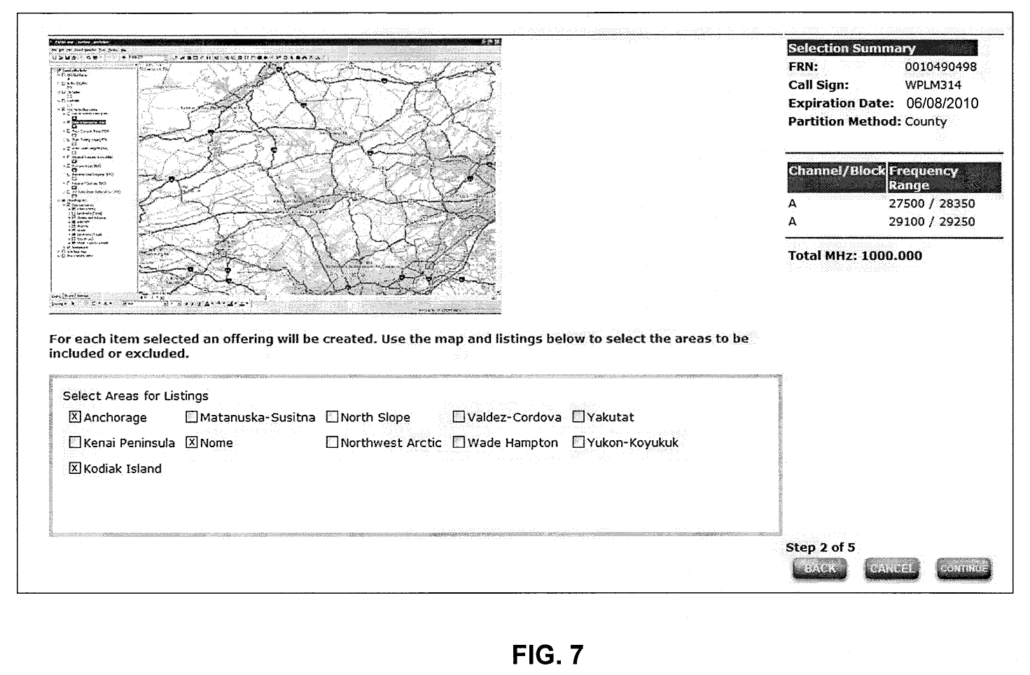

After a spectrum holder has selected the license and specified any apportioning parameters, a spectrum holder may identify the offering area. FIG. 7 depicts a screenshot of a portion of an exemplary GUI from which a spectrum holder may identify an offering area for offering spectrum rights. Note that FIG. 7 carries over the information from the example of FIGS. 6A-6C. For example, the right portion of FIG. 7 contains identifying information for the specified license, such as the FRN, call sign, and expiration date for the license. Also depicted are the apportioning parameters, including the selected geographic partitioning method (county) and the selected frequency channels or blocks to be included in the offering. In addition, FIG. 7 depicts a map corresponding to the geographic area encompassed by the specified spectrum license. In this particular example, the spectrum license encompasses a portion of Alaska.

FIG. 7 further includes portions of the exemplary GUI for identifying a geographic area for the offering. In this example in which geographic partitioning by county has been selected, the GUI includes selectable counties to be included in the offering. Generally, the selectable geographic areas correspond to the geographic partitioning method selected previously, and comprise a list of the partitioning units encompassed by the FCC license. In this example, the license encompasses eleven counties, each representing a selectable option. Had 5-digit zip code been selected as the partitioning method, a list of selectable zip codes encompassed by the license would be displayed. Had BTA been selected as the partitioning method, a list of selectable BTAs encompassed by the license would be displayed, and so on. Therefore, the holder may break-up the spectrum on any applicable geographic partition unit using criteria established by the holder to achieve a desired partitioning objective and/or satisfy spectrum demand. In the example of FIG. 7, the spectrum holder has selected the counties of Anchorage, Kodiak Island, and Nome to be included in the offering, as indicated by the “x” marks in the boxes adjacent these counties. In other words, the spectrum holder has decided to offer spectrum rights in the selected channel bands for the geographic area including the counties of Anchorage, Kodiak Island, and Nome.

In another embodiment, the identification of the offering area may include a map-based input in addition to or alternatively to the selection inputs. For example, FIG. 7 includes a geographic map of the selected spectrum license. A spectrum holder may identify an offering area by drawing the offering area directly onto the map with a stylus or other input instrument. To facilitate user inputs, the display on which the GUI is generated may include a touch screen surface for receiving map-based and selection inputs. In other embodiments, the offering area may be defined by the user with a set of coordinates.

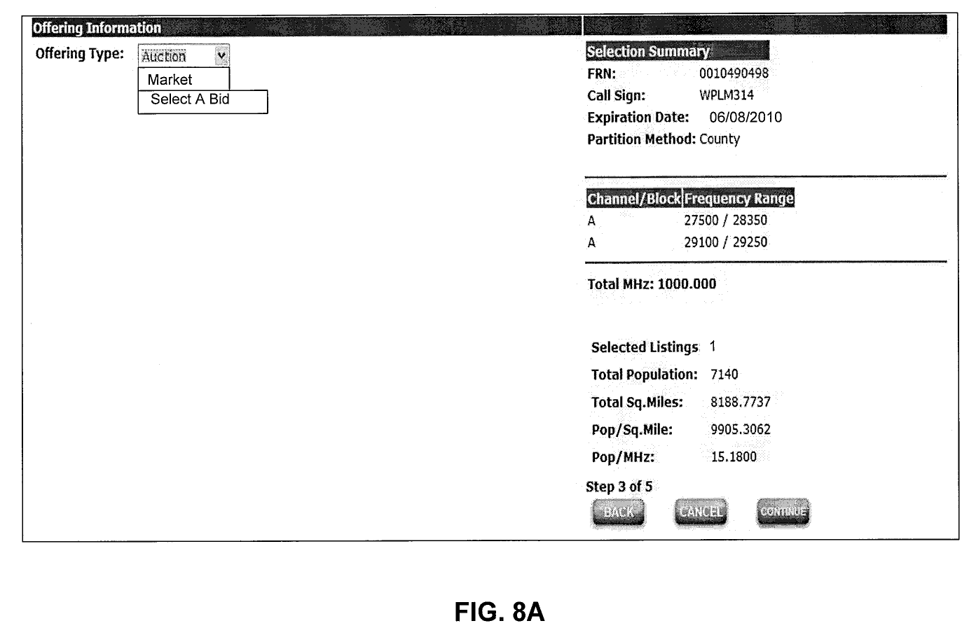

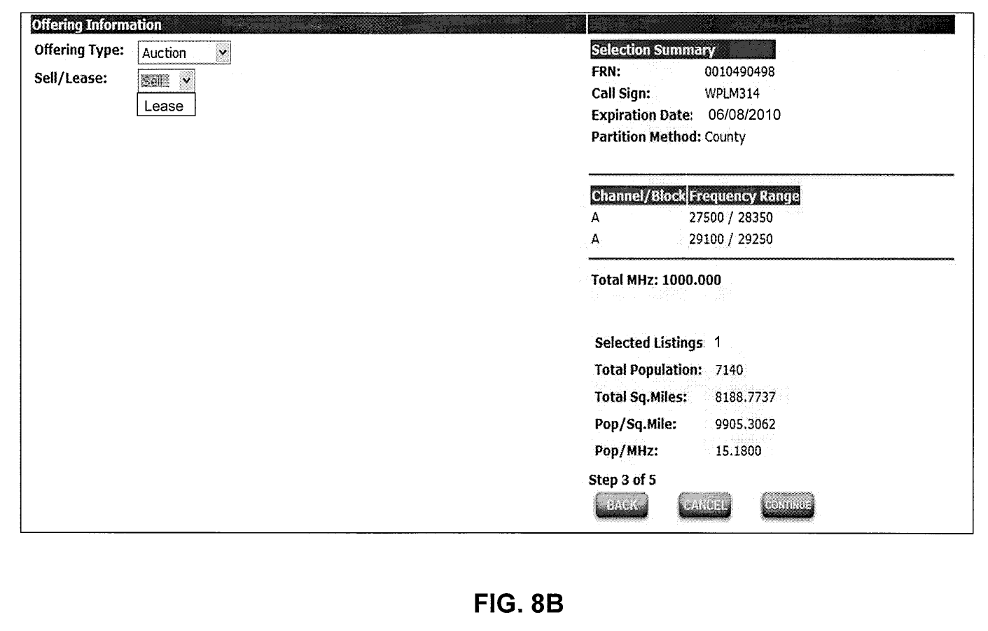

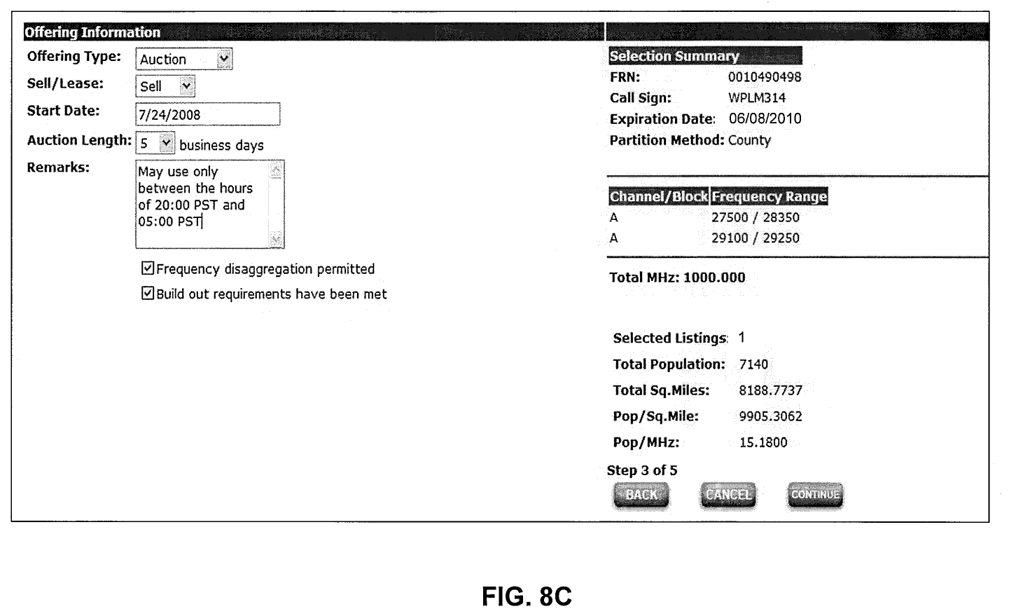

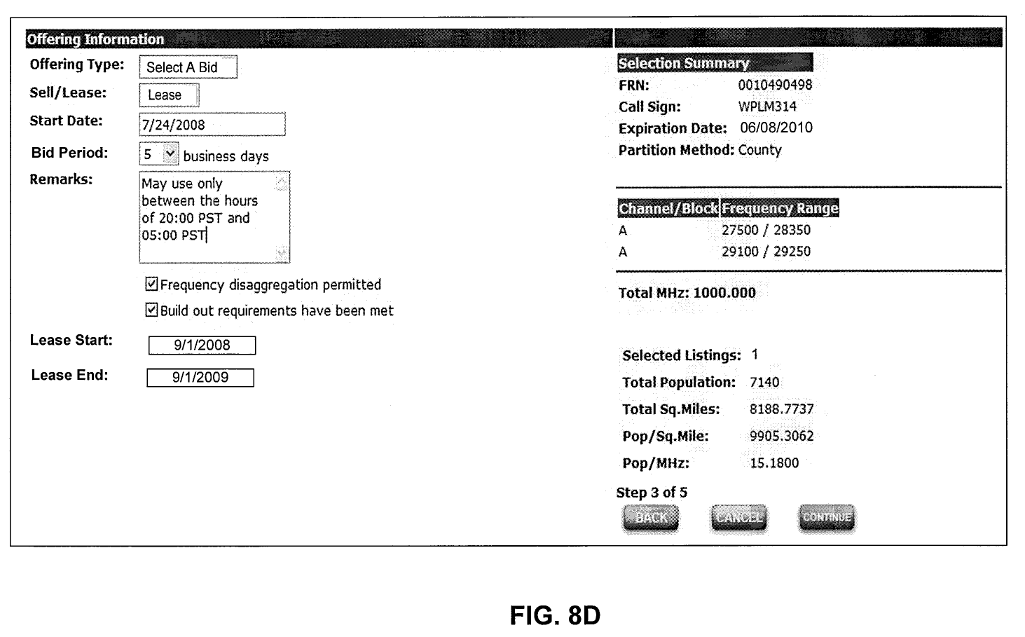

After a spectrum holder has identified the offering area, a spectrum holder may define various offering details. FIGS. 8A-8D depict screenshots of a portion of an exemplary GUI from which a spectrum holder may define offering details for offering spectrum rights. Note that FIGS. 8A-8D carry over the information from the examples of the preceding figures. For example, the right portion of FIGS. 8A-8D also contain identifying information for the selected license, such as the FRN, call sign, and expiration date for the license. Also depicted again are the apportioning parameters, including the selected geographic partitioning method (county) and the selected frequency channels or blocks to be included in the offering. Having previously defined an offering area (the three counties of Anchorage, Kodiak Island, and Nome), the GUI may further include additional information corresponding to the offering area. For example, FIGS. 8A-8D include the total population of the offering area, the total square miles of the offering area, the population per square mile, and the population per megahertz of the offering. FIGS. 8A-8D also indicate that information is being displayed for a “Selected Listings: 1”. An offering may include more than one listing, with each listing having its own distinct associated spectrum rights. A spectrum holder may specify or define offering details for each listing in the offering. For simplicity, the offering of the current example includes only one listing.

FIGS. 8A-8D further depict portions of the exemplary GUI for defining details of the spectrum offering. Referring to FIG. 8A, a spectrum holder may first have an option for selecting a particular offering type. Three exemplary offering types are shown as selectable items from a dropdown menu: auction, market, and “select a bid”. In an auction offering, prospective spectrum users may bid upon the offered spectrum rights, with the rights being awarded to the highest bidder. In a market offering, the spectrum holder may set a specific price, and the spectrum rights may be awarded to the first qualified bidder that places a bid at the market price. In a “select a bid” offering, a spectrum holder would have the flexibility to view individual bids and award the spectrum rights based on parameters in addition to price, which may be either objective or subjective to the spectrum holder. For example, a holder may have a preference for bidding entities with which the holder has an established business relationship, bidders with a particular intended use, or bidders preferred based on other objective and subjective preferences of the holder. It will be appreciated that the auction, market, and “select a bid” type offerings are examples, and other offering types may be developed and employed. In the present example, the holder has selected an auction offering, as indicated in FIG. 8A by the shading.

Referring to FIG. 8B, a spectrum holder may also specify whether the offering is for a sale or lease. For example, in a “sell” offering, a spectrum holder may offer all rights encompassed by the FCC license and delineated by any partitioning parameters (geographic area and/or frequency blocks). In this manner, the holder may fully divest the holder's use rights in the specified spectrum. In a “lease” offering, a spectrum holder may offer a transfer of spectrum rights for time period less that the full term of the FCC license. The time period may be in the future or include the present. Using the interface, futures and options on spectrum may be created. In the example of FIG. 8B, the spectrum holder has selected a sell offering, as indicated by the shading.

Once the spectrum holder has specified an offering type, the spectrum holder may define additional details regarding the offering. For example, FIG. 8C depicts exemplary details of an offering type corresponding to the selection of an auction/sale offering from FIGS. 8A and 8B. As an auction, a spectrum holder may input an auction start date and length using text inputs, dropdown menus, or other conventional means. There also is a “Remarks” section by which the spectrum holder may input any comments or other pertinent details regarding the spectrum rights and/or the offering itself. In the example of FIG. 8C, the spectrum holder has entered a time-of-use restriction. A holder may desire such a restriction to prevent interference with usages by other entities (which may include usage by the holder itself). The “Remarks” section may also identify any FCC service rules that may apply to the offered spectrum. As stated above, in the U.S. service rules are typically specified under an FCC “Part” number. The service rules under each license refer to an application and/or the type of radio technology that may use the licensed spectrum. In the example of FIG. 8C, two check-box items are displayed, which permit the spectrum holder to provide additional information about the offered spectrum and/or the offering itself. It will be appreciated that the offering details depicted in FIG. 8C represent an example, and the configuration, content, and format of the offering details may be varied.

FIG. 8D depicts a different set of offering details based on a different selection of offering type. In the example of FIG. 8D, the spectrum holder has selected a “Select A Bid”/Lease offering type. As a result, some of the offering details differ from the details of FIG. 8C. For example, instead of an auction length, FIG. 8D specifies a bid period from the start date insofar as the offering is a “select a bid” type. In addition, because the offering is a lease offering, lease start and end dates are specified to define the lease term. Note that the lease term of Sep. 1, 2008 through Sep. 1, 2009 falls within the FCC license period, which expires on Jun. 8, 2010 in this example. It will be appreciated that numerous combinations of inputs may result in a variety of offering types, and the resultant display of offering details would be commensurate with the specified offering type.

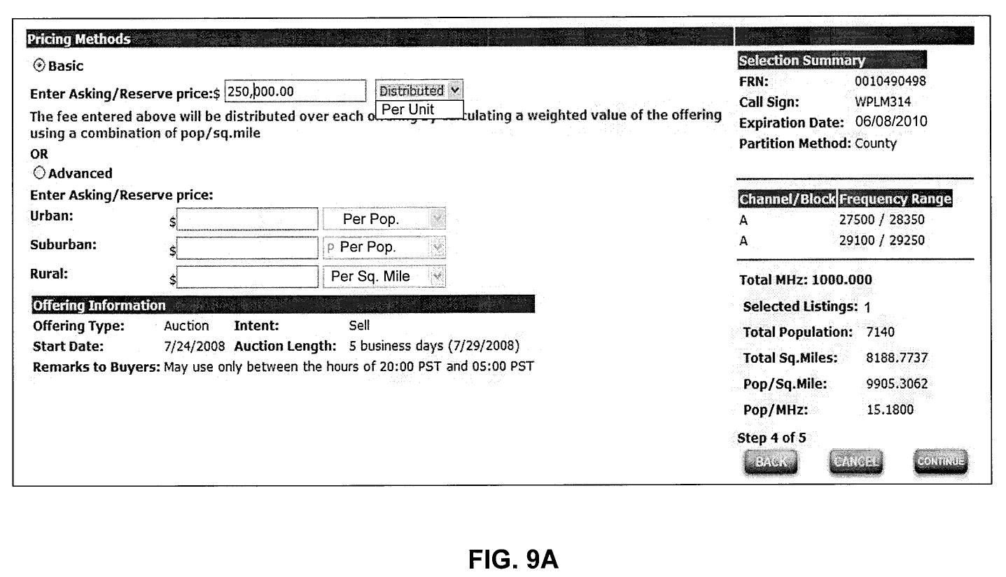

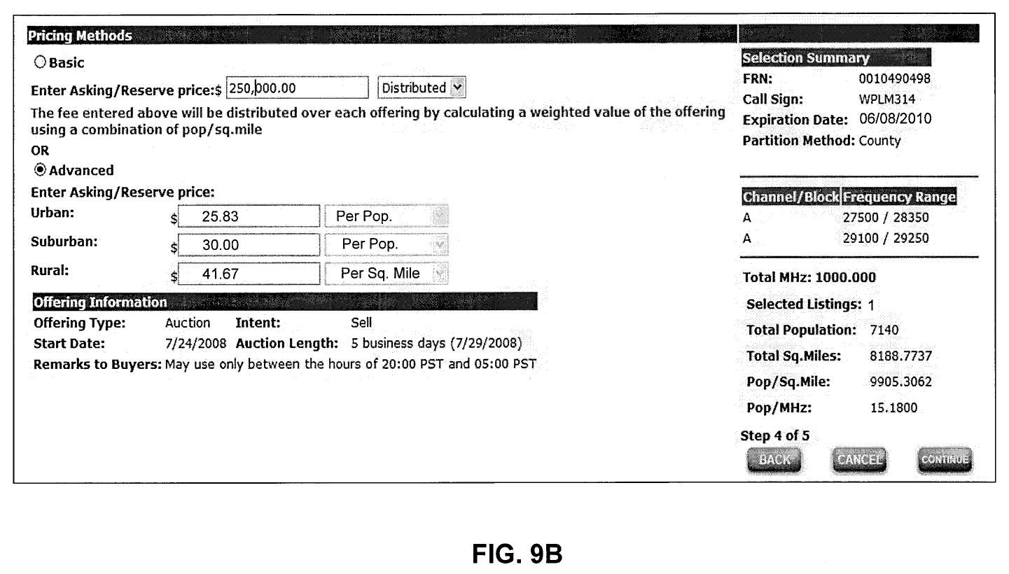

Once the spectrum holder has defined the various offering details, the spectrum holder may next price the offering. FIGS. 9A-9B depict screenshots of a portion of an exemplary GUI from which a spectrum holder may specify the price parameters for an offering of spectrum rights. Note that FIGS. 9A-9B carry over the information from the examples of the preceding figures. For example, as seen in the right portion of FIG. 9A, the FRN, call sign, partitioning method, and other details regarding the offering are comparable to the information depicted in the right side portion of FIG. 8A. In addition, the example of FIG. 9A corresponds to the offering type carried over from the example of FIG. 8C. In other words, the offering type in the pricing example is an Auction/Sell offering type.

A holder may initially input an asking or reserve price. It will be appreciated that whether the price input is an asking or reserve price will depend upon the offering type. For example, in the case of an auction or “select a bid” type offering, the price would be a reserve price, meaning that the price represents a minimum sale price. If the auction or user bids do not reach the reserve price, the transfer of rights would not proceed. In the case of a market offering type, the price would represent the asking price of the spectrum rights. In the example of FIG. 9A, because the offering type is an auction, the illustrated price of $250,000.00 represents a reserve price.

Another parameter that may be entered by the spectrum holder is whether the price is a distributed price or a unit price. In the case of a distributed price, the price represents a total of weighted prices for each individual partitioning unit. In this example, in which the partitioning method is by county, counties having a relatively larger population and/or physical area may contribute more to the overall price than counties having a relatively smaller population and/or physical area. Thus, for example, Anchorage may contribute more to the offering price than Kodiak Island and Nome. In the case of unit pricing, the price per partitioning unit is the same. In this example, each of the three counties of Anchorage, Kodiak Island, and Nome would account for a third of the offering price if unit pricing were selected.

In one embodiment, a spectrum holder need not enter any additional pricing information. As seen in the example of FIG. 9A, this limited pricing method is identified as a selectable “Basic” pricing method. Bids may then be received based solely upon these limited pricing parameters. An alternative pricing method may include an “Advanced” pricing option that would permit a spectrum holder to price the offering at a more detailed level, as further described below.

FIG. 9B depicts a screenshot of a portion of an exemplary GUI from which a spectrum holder may employ an advanced pricing option. In this example, the advanced pricing option permits a spectrum holder to enter specific pricing for urban, suburban, and rural portions of the geographic area of the offering. Other breakdowns may be employed. For example, a spectrum holder may enter a specific price for each partitioning unit, such as for each county in this example. The advanced option also permits the spectrum holder to price the offering based on a variety of parameters that are selectable from a drop down menu. For example, in FIG. 9B the spectrum holder has selected to price urban and suburban areas by population (Per Pop.) and rural areas by square mile (Per Sq. Mile). It will be appreciated that other pricing parameters, such as price per megahertz, price per zip code, price per census block, or others may be employed. Also, price by a combination of parameters may be used, such as price per population per megahertz.

The advanced pricing operation may operate in a variety of ways. For example, in one embodiment the spectrum holder may simply input the desired pricing values directly into the various fields. In another exemplary embodiment, the basic and advanced pricing options may be combined. Specifically, a spectrum holder may input the total asking/reserve price in the basic pricing section, and then the application may calculate the specific pricing values in the advanced pricing section from the overall price. If the specific pricing values are acceptable, the spectrum holder may accept the values for the offering. If, however, one or more specific pricing values are considered by the holder to be too low or too high, the spectrum holder may edit them manually. It will be appreciated that in this embodiment, the total asking/reserve price in the basic pricing section and the specific pricing values in the advanced pricing section are linked. In other words, an edit to one or more of the specific pricing values will cause a recalculation of the overall price (and other specific pricing values), and vice versa.

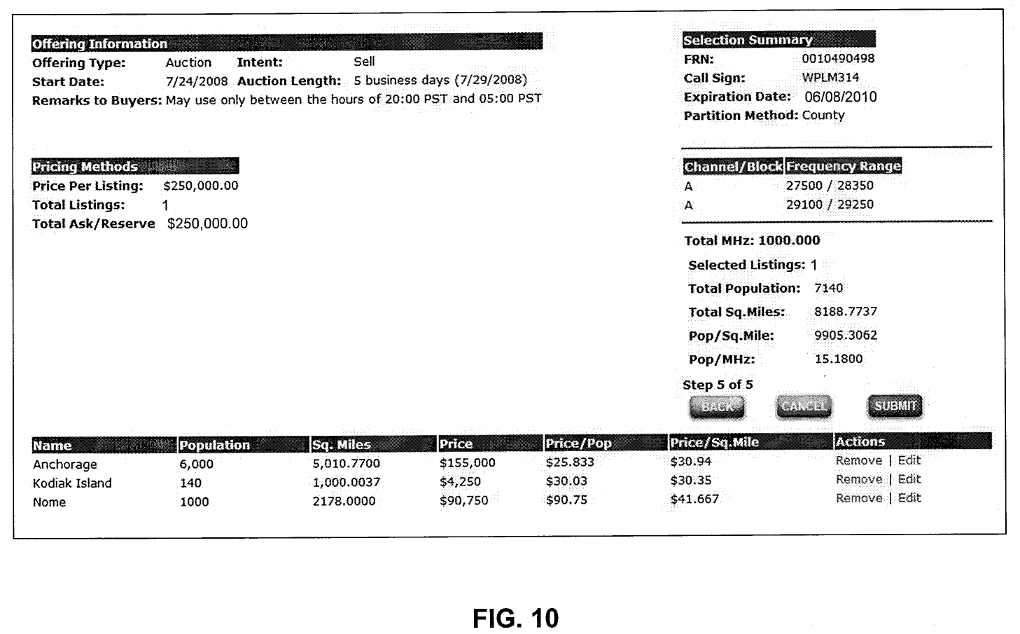

Once the spectrum holder has priced the offering, the spectrum holder may be provided with a summary and submission screen. FIG. 10 depicts a screenshot of a portion of an exemplary GUI that provides a spectrum holder with a summary and submission option for the offering. Note that FIG. 10 carries over the information from examples of the preceding figures. This screenshot also provides additional indications of the distributed nature of this exemplary offering. As seen in the bottom portion of the figure, Anchorage, being both more populous and geographically larger than the other counties, contributes substantially more to the overall price of the offering. In an example of per unit pricing, the price would be the same for each county in the offering, that county price equaling one third of the overall price. In FIG. 10, more specific pricing values (per population and per square mile) also are shown for each county. A spectrum holder may thus review the entire offering from this exemplary screen. A holder may then submit the offering, or may return to one or more of the GUI screens or pricing items to edit the offering.

It will be appreciated that the GUI depicted in FIGS. 6A-10 is intended to be an example. The content, configuration, and format of the GUI (and any portion thereof) may be varied without departing from the scope of the invention.

Referring again to FIG. 4, a spectrum holder may generate an offering in the manner described above using any suitable electronic device, such as one of the client devices 21. The offering may then be transmitted to and/or stored in a network database, such as the spectrum offerings database 74. Once in a network database, another participant in the system, such as a prospective spectrum user, may access and review the offering. For example, a spectrum user may employ a client device 21 to access an offering stored in the network database 74. In a membership based system, spectrum users may maintain accounts containing usage information and a bidding interface. A spectrum user may then transmit a bid in accordance with the offering parameters from a client device 21, which may be received over the network by the spectrum holder that generated the offering. Any bids may then be processed by the system or spectrum holder in accordance with the type of offering (auction, market, or “select a bid”) and associated offering details.

In one embodiment, a spectrum user may search the database of offerings to find an offering of desirable spectrum. For example, a user may input a query of text-based parameters, such as, for example, geographic, frequency, and time parameters. In another embodiment, search capabilities may include a map-based search by which a user may search for offerings by selecting a region on a map. Sequential maps may be employed by which a user may select regions with increasing precision. For example, a user may begin with a national or regional map from which to select a state. From a state map of the selected state, the user may select a portion of the state (such as a county), and then a zip code within the county, and so on until the user may select the area specifically desired. Combinations of text-based and map-based searching may also be employed.

In addition, a given entity may be both a spectrum holder and a spectrum user, and thus maintain an account from which both offerings and bids may be generated. The disclosed system and methods, therefore, provide a convenient and efficient manner by which spectrum holders may generate and disseminate offerings of disaggregated spectrum rights, which may then be bid upon by prospective spectrum users. In one embodiment, the offerings may be posted to an automated spectrum exchange where users post bids that are matched to offerings to establish a transfer of spectrum user rights from holder to user.

Although certain embodiments have been shown and described, it is understood that equivalents and modifications falling within the scope of the appended claims will occur to others who are skilled in the art upon the reading and understanding of this specification.

What is claimed is:

1. A program stored on computer readable medium for generating a spectrum rights offering, the program comprising executable logic to:
select spectrum from which the offering is to be generated;
specify at least one partitioning parameter to partition the selected spectrum;
identify an offering area based on the at least one partitioning parameter;
price the offering; and
generate an offering to which a bid for spectrum rights may be received in response to the offering, the offering being based on the offering area and the price.

2. The program of claim 1, wherein the selected spectrum comprises spectrum encompassed by an FCC license.

3. The program of claim 2, wherein the spectrum is selected by receiving an input of an FCC registration number (FRN) and a call sign associated with the FCC license.

4. The program of claim 1, wherein the at least one partitioning parameter includes a geographic unit for partitioning the selected spectrum.

5. The program of claim 4, wherein the geographic unit comprises one of county, 5-digit zip code, three digit zip code, state, census block, or an FCC-defined area.

6. The program of claim 5, wherein the FCC-defined area comprises one of a Major Trading Area (MTA), Basic Trading Area (BTA), Cellular Market Area, or Economic Area Grouping.

7. The program of claim 4, further comprising executable logic to disaggregate the spectrum by specifying at least one frequency block.

8. The program of claim 4, wherein the offering area is identified by selecting at least one geographic area corresponding to a geographic unit of the partitioning parameter.

9. The program of claim 8, wherein the offering price is distributed such that each selected geographic area contributes to an overall offering price in a proportion weighted based on population within the corresponding geographic area.

10. The program of claim 9, wherein the offering price is distributed such that each selected geographic area contributes to an overall offering price in a proportion further weighted based on physical area within the corresponding geographic area.

11. The program of claim 8, wherein the offering price is a geographic unit based price such that each selected geographic area contributes an equal amount to an overall offering price.

12. The program of claim 4, wherein the offering area is identified by receiving a map-based input by which a user inputs the offering area directly onto a map display.

13. The program of claim 1, further comprising executable logic to identify an offering type.

14. The program of claim 13, wherein the offering type is one of an auction offering, a market offering, or a select a bid offering that allows a holder of the selected spectrum to accept one of plural bids.

15. The program of claim 14, wherein the offering type is an auction, and the program further comprises executable logic to specify an auction start date and an auction length.

16. The program of claim 14, wherein the offering type is one of a market or select a bid offering, and the program further comprises executable logic to specify a start date and a bid period.

17. The program of claim 13, wherein the offering type comprises one of a sell offering or a lease offering.

18. The program of claim 17, wherein the offering type is a lease offering, and the program further comprises executable logic to specify a lease period.

19. The program of claim 13, further comprising executable logic to identify at least one restriction on the usage of the offered spectrum.

20. The program of claim 14, wherein the offering type is one of an auction or a select a bid offering, and the offering is priced by receiving an input of a reserve price for the offering.

21. The program of claim 14, wherein the offering type is a market offering, and the offering is priced by receiving an input of an asking price for the offering.

22. The program of claim 1, wherein the offering is priced for the offering area by receiving an input of at least one of price per population, price per square mile, price per megahertz, or price per geographic unit that is smaller than the partitioning parameter.

23. The program of claim 8, wherein the offering is priced by receiving an input for each geographic area within the offering area of at least one of price per population, price per square mile, price per megahertz, or price per geographic unit that is smaller than the partitioning parameter.

24. The program of claim 1, wherein the program, when executed, comprises a graphical user interface for generating the spectrum rights offering.

25. A method for generating a spectrum rights offering comprising the steps of:
selecting spectrum from which the offering is to be generated;
specifying at least one partitioning parameter to partition the selected spectrum;
identifying an offering area based on the at least one partitioning parameter;
pricing the offering; and
generating an offering to which a bid for spectrum rights may be received in response to the offering, the offering being based on the offering area and the price.

26. The method of claim 25, wherein the selected spectrum comprises spectrum encompassed by an FCC license.

27. The method of claim 26, wherein the spectrum is selected by receiving an input of an FCC registration number (FRN) and a call sign associated with the FCC license.

28. The method of claim 25, wherein the at least one partitioning parameter includes a geographic unit for partitioning the selected spectrum.

29. The method of claim 28, wherein the geographic unit comprises one of county, 5-digit zip code, three digit zip code, state, census block, or an FCC-defined area.

30. The method of claim 29, wherein the FCC-defined area comprises one of a Major Trading Area (MTA), Basic Trading Area (BTA), Cellular Market Area, or Economic Area Grouping.

31. The method of claim 28, further comprising disaggregating the spectrum by specifying at least one frequency block.

32. The method of claim 28, wherein the offering area is identified by selecting at least one geographic area corresponding to a geographic unit of the partitioning parameter.

33. The method of claim 32, wherein the offering price is distributed such that each selected geographic area contributes to an overall offering price in a proportion weighted based on population within the corresponding geographic area.

34. The method of claim 33, wherein the offering price is distributed such that each selected geographic area contributes to an overall offering price in a proportion further weighted based on physical area within the corresponding geographic area.

35. The method of claim 32, wherein the offering price is a geographic unit based price such that each selected geographic area contributes an equal amount to an overall offering price.

36. The method of claim 28, wherein the offering area is identified by receiving a map-based input by which a user inputs the offering area directly onto a map display.

37. The method of claim 25, further comprising identifying an offering type.

38. The method of claim 37, wherein the offering type is one of an auction offering, a market offering, or a select a bid offering that allows a holder of the selected spectrum to accept one of plural bids.

39. The method of claim 38, wherein the offering type is an auction, and the method further comprises specifying an auction start date and an auction length.

40. The method of claim 38, wherein the offering type is one of a market or select a bid offering, and the method further comprises specifying a start date and a bid period.

41. The method of claim 37, wherein the offering type comprises one of a sell offering or a lease offering.

42. The method of claim 41, wherein the offering type is a lease offering, and the method further comprises specifying a lease period.

43. The method of claim 37, further comprising identifying at least one restriction on the usage of the offered spectrum.

44. The method of claim 38, wherein the offering type is one of an auction or a select a bid offering, and the offering is priced by receiving an input of a reserve price for the offering.

45. The method of claim 38, wherein the offering type is a market offering, and the offering is priced by receiving an input of an asking price for the offering.

46. The method of claim 25, wherein the offering is priced for the offering area by receiving an input of at least one of price per population, price per square mile, price per megahertz, or price per geographic unit that is smaller than the partitioning parameter.

47. The method of claim 32, wherein the offering is priced by receiving an input for each geographic area within the offering area of at least one of price per population, price per square mile, price per megahertz, or price per geographic unit that is smaller than the partitioning parameter.
